(19) United States
(12) Patent Application Publication
(10) Pub. No.: US 2011/0229033 A1
(43) Pub. Date: Sep. 22, 2011

(54) Image Processing Method, and Program

(76) Inventor: Mohammad Abdul Muquit, Tokyo (JP)

(21) Appl. No.: 13/130,133

(22) PCT Filed: Oct. 2, 2009
(86) PCT No.: PCT/JP2009/067246

§ 371 Date: May 19, 2011

(30) Foreign Application Priority Data
Dec. 5, 2008 (JP) 2008-311029

(51) Int. Cl. G06K 9/00

(52) U.S. Cl. 382/171

(57) ABSTRACT

An image processing apparatus according to the present invention includes a run-length encoding unit for performing run-length encoding processing on input data and outputting a data value of each element constituting the data and a frequency of the element having the data value, a pixel frequency information extraction unit for extracting pixel frequency information representing frequencies of the background pixel and the outline pixel constituting the target region from among output values of the processing target region processed by the run-length encoding unit, and a pixel frequency information dividing unit for dividing the pixel frequency information extracted by the pixel extraction unit into frequency information about the background pixel and frequency information about the outline pixel, wherein the run-length encoding processing is further performed on the frequency information about the outline pixel. Therefore, high-speed lossless compression can be performed on a binary outline image with high accuracy.

### TECHNICAL FIELD

The present invention relates to an image processing apparatus, an image processing method, and a program.

### BACKGROUND ART

A binary image, i.e., binarized image information, is used for a character image, a fingerprint image, a blood vessel image, and the like. The binary image is used not only for these images but also for the purpose of indicating a portion having a different brightness in an image and distinguishing an object from a background in an image. When the binary image is stored, the binary image is subjected to compression processing (for example, lossless compression processing). As a result, more images can be stored.

Examples of methods generally used for the lossless compression processing include run-length encoding and chain encoding. The run-length encoding has an issue in that the compression efficiency decreases depending on the type of an image to be compressed. On the other hand, the chain encoding can efficiently compress even an image for which the run-length encoding can achieve only low compression efficiency, but the chain encoding has an issue in that it takes a longer computation time than the run-length encoding. As described above, in the past, it is necessary to select a method of compression processing in accordance with the type of an image to be processed.

Patent Literature 1 listed below discloses a method for dividing a binary image into a plurality of rectangles each including the same pixel value and compressing each of the rectangles, thus efficiently compressing even an image for which the run-length encoding can achieve only low compression efficiency.

### CITATION LIST

### Patent Literature

Patent Literature 1: JP 2004-140749

### SUMMARY OF INVENTION

### Technical Problem

The method described in Patent Literature 1 needs processing for scanning the entire binary image in vertical and horizontal directions and generating a plurality of rectangles, and information about a pixel number on a line, a rectangle length, a rectangle width, and the like is associated with each of the generated rectangles. At this occasion, when pixel values frequently change in an image (for example, an outline image constituted by outlines), the number of generated rectangles increases. Therefore, there is an issue in that the compression rate may decrease depending on the information associated with the rectangles.

The present invention is made in view of the above-mentioned issue, and aims to provide a novel and improved image processing apparatus, image processing method, and program capable of performing lossless compression on a binary outline image with high accuracy at a high speed.

### Solution to Problem

According to an aspect of the present invention in order to achieve the above-mentioned object, there is provided an image processing apparatus including: a processing target region selection unit for determining whether a binary image including a background pixel having a pixel value representing a background and an outline pixel having a pixel value representing an outline includes any row or column including only the background pixels, and selecting, from pixels representing the binary image, a processing target region from which the row and the column including only the background pixels have been removed; a run-length encoding unit for performing run-length encoding processing on input data, and outputting a data value of each element constituting the data and a frequency of the element having the data value; a pixel frequency information extraction unit for extracting pixel frequency information representing frequencies of the background pixel and the outline pixel constituting the target region from among output values of the processing target region processed by the run-length encoding unit; and a pixel frequency information dividing unit for dividing the pixel frequency information extracted by the pixel extraction unit into frequency information about the background pixel and frequency information about the outline pixel, wherein the run-length encoding unit performs the run-length encoding processing on the frequency information about the outline pixel.

According to the above configuration, the processing target region selection unit determines whether the binary image includes any row or column including only the background pixels, and selects, from pixels representing the binary image, a processing target region from which the row and the column including only the background pixels have been removed. The run-length encoding unit performs run-length encoding processing on input data, and outputs a data value of each element constituting the data and a frequency of the element having the data value. The pixel frequency information extraction unit extracts pixel frequency information representing frequencies of the background pixel and the outline pixel constituting the target region from among the output values of the processing target region processed by the run-length encoding unit. The pixel frequency information dividing unit divides the pixel frequency information extracted by the pixel extraction unit into the frequency information about the background pixel and the frequency information about the outline pixel. The run-length encoding unit further performs the run-length encoding processing on the frequency information about the outline pixel. Therefore, the frequency information about the outline pixel can be further compressed.

The run-length encoding unit preferably divides the processing target region into a plurality of rows or columns in units of pixels, and performs the run-length encoding processing on one data array obtained by connecting the plurality of rows or columns in order.

The run-length encoding unit preferably performs the run-length encoding processing on the frequency information about the outline pixel to output information about the number of continuous outline pixels and information about a frequency of the number of continuous outline pixels, and the image processing apparatus preferably further includes an encoded information generation unit for obtaining encoded information, which is information obtained by encoding the binary image, upon associating, with each other, information about the number of the rows and the columns including only the background pixels, the frequency information about the background pixel, the information about the number of continuous outline pixels, and the information about the frequency of the number of continuous outline pixels.

A curve representing an outline constituted by the outline pixels preferably has substantially the same width.

The binary image may be a binary image of a vein existing in a living body.

According to another aspect of the present invention in order to achieve the above-mentioned object, there is provided an image processing method including the steps of determining whether a binary image including a background pixel having a pixel value representing a background and an outline pixel having a pixel value representing an outline includes any row or column including only the background pixels, and selecting, from pixels representing the binary image, a processing target region from which the row and the column including only the background pixels have been removed; performing run-length encoding processing on data representing the processing target region, and outputting a pixel value of each pixel constituting the data representing the processing target region and a frequency of the pixel having the pixel value; extracting pixel frequency information representing frequencies of the background pixel and the outline pixel constituting the target region from among output values of the processing target region; dividing the extracted pixel frequency information into frequency information about the background pixel and frequency information about the outline pixel; and performing the run-length encoding processing on the frequency information about the outline pixel.

According to still another aspect of the present invention in order to achieve the above-mentioned object, there is provided a program for causing a computer to execute: a procedure for determining whether a binary image including a background pixel having a pixel value representing a background and an outline pixel having a pixel value representing an outline includes any row or column including only the background pixels, and selecting, from pixels representing the binary image, a processing target region from which the row and the column including only the background pixels have been removed; a procedure for performing run-length encoding processing on data representing the processing target region, and outputting a pixel value of each pixel constituting the data representing the processing target region and a frequency of the pixel having the pixel value; a procedure for extracting pixel frequency information representing frequencies of the background pixel and the outline pixel constituting the target region from among output values of the processing target region; a procedure for dividing the extracted pixel frequency information into frequency information about the background pixel and frequency information about the outline pixel; and a procedure for performing the run-length encoding processing on the frequency information about the outline pixel.

### Advantageous Effects of Invention

According to the present invention, the run-length encoding processing is performed again on the frequency information about the outline pixel obtained by performing the run-length encoding processing on the binary outline image. Therefore, lossless compression can be performed on a binary outline image with high accuracy at a high speed.

### BRIEF DESCRIPTION OF DRAWINGS

FIG. 1A is an explanatory diagram for illustrating a type of a binary image.

FIG. 1B is an explanatory diagram for illustrating a type of a binary image.

FIG. 1C is an explanatory diagram for illustrating a type of a binary image.

FIG. 1D is an explanatory diagram for illustrating a type of a binary image.

FIG. 2A is an explanatory diagram for illustrating a run-length encoding method.

FIG. 2B is an explanatory diagram for illustrating the run-length encoding method.

FIG. 2C is an explanatory diagram for illustrating the run-length encoding method.

FIG. 3A is an explanatory diagram for illustrating the run-length encoding method.

FIG. 3B is an explanatory diagram for illustrating the run-length encoding method.

FIG. 3C is an explanatory diagram for illustrating the run-length encoding method.

FIG. 4 is an explanatory diagram for illustrating a chain encoding method.

FIG. 5 is a block diagram for illustrating a configuration of an image processing apparatus according to a first embodiment of the present invention.

FIG. 6 is an explanatory diagram for illustrating the image processing apparatus according to the embodiment.

FIG. 7 is an explanatory diagram for illustrating the image processing apparatus according to the embodiment.

FIG. 8 is a flow diagram for illustrating an image processing method according to the embodiment.

FIG. 9 is an explanatory diagram for illustrating an example of application of the image processing method according to the embodiment.

FIG. 10 is an explanatory diagram for illustrating a result of image processing using the chain encoding method.

FIG. 11 is a block diagram for illustrating a hardware configuration of an image processing apparatus according to an embodiment of the present invention.

### REFERENCE SIGNS LIST

10 image processing apparatus
101 processing target region selection unit
103 run-length encoding unit
105 primary run-length encoding unit
107 pixel frequency information extraction unit
109 pixel frequency information dividing unit
111 secondary run-length encoding unit
113 encoding information generation unit
115 storage unit

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

The explanation will be made in the order listed below.

(1) Purpose

(2) Fundamental technique serving as a basis of the present invention

(3) First embodiment
(3-1) Configuration of image processing apparatus
(3-2) Image processing method
(3-3) Actual result of processing

(4) Hardware configuration of image processing apparatus according to each embodiment of the present invention

(5) Summary

### <Purpose>

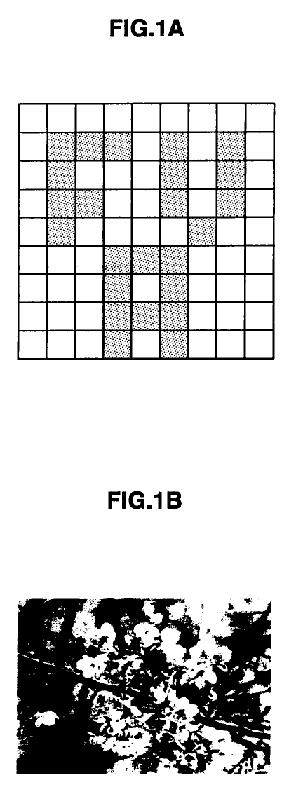

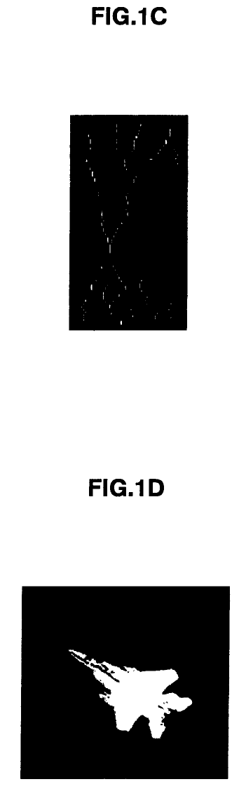

Before explaining an image processing apparatus and an image processing method according to each embodiment of the present invention, an aim of the present invention will be explained in detail with reference to FIGS. 1A to 1D.

FIGS. 1A to 1D are explanatory diagrams each illustrating a type of a binary image. Binary images can be roughly classified into ordinary images and outline images (which may be also referred to as contour images) according to the densities of image information in the images. Examples of ordinary images include a generally-available monochrome facial images, landscape images, and silhouette images of objects. FIGS. 1B and 1D are ordinary images. On the other hand, examples of outline images include edge images and pattern images. FIGS. 1A and 1C are outline images.

As described above, methods used for performing lossless compression on the binary image as shown in FIGS. 1A to 1D include the run-length encoding and the chain encoding.

In the run-length encoding method does not record a pixel value of each pixel constituting a binary image but records how many pixels having a certain pixel value continuously appear in the binary image. Accordingly, the run-length encoding can achieve extremely high compression efficiency on the binary natural image as shown in FIG. 1B and the silhouette image including the object and the background as shown in FIG. 1D. On the contrary, in the character image and the pattern image (i.e., so-called outline images) as shown in FIGS. 1A and 1C, pixel values between adjacent pixels change greatly, which decreases the compression efficiency.

The chain encoding method tracks directions in which a pattern extends from a given start point (i.e., a given pixel) and records the directions in which the pattern extends. Therefore, the chain encoding method can achieve high compression efficiency to compress even an image in which pixel values of adjacent pixels change rapidly and for which the run-length encoding method can achieve only low compression efficiency. However, since the chain encoding method tracks the directions in which the pattern extends, it is necessary to look up eight pixels located in proximity to each pixel. Therefore, there is an issue in that the chain encoding method takes a longer computation time than the run-length encoding method.

Accordingly, the present invention aims to provide an image processing apparatus and an image processing method capable of performing highly-accurate/high-speed lossless compression even on a binary outline image for which the run-length encoding method in the related art achieves only low compression efficiency.

### <Technique Serving as a Basis of the Present Invention>

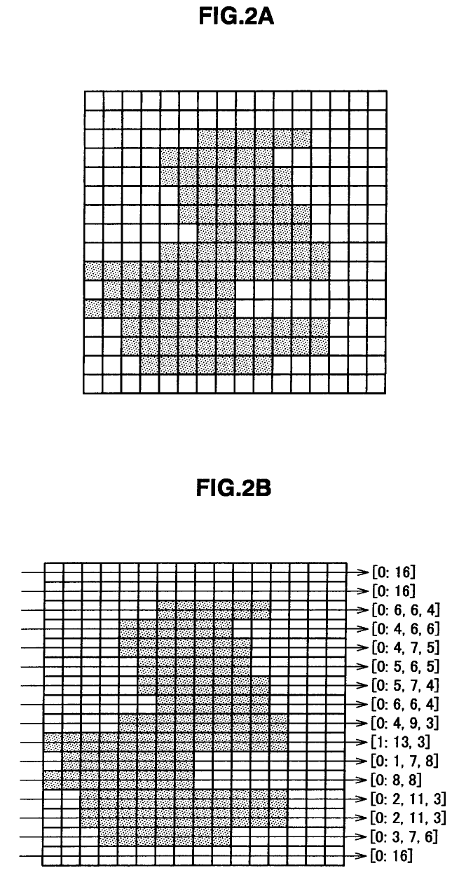

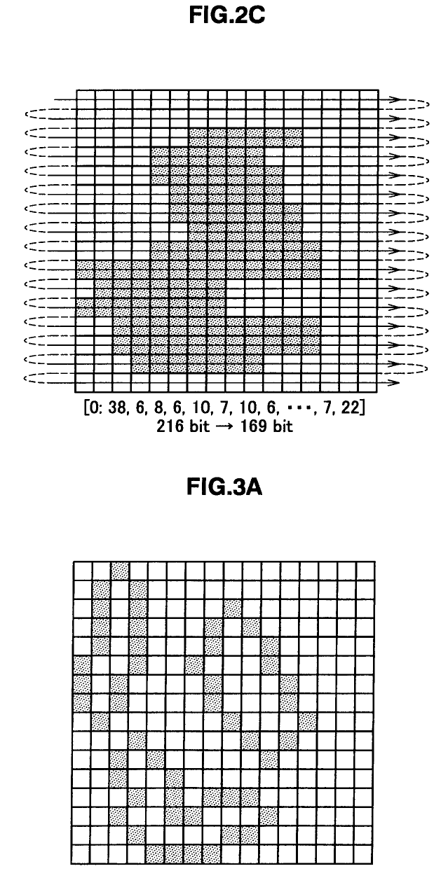

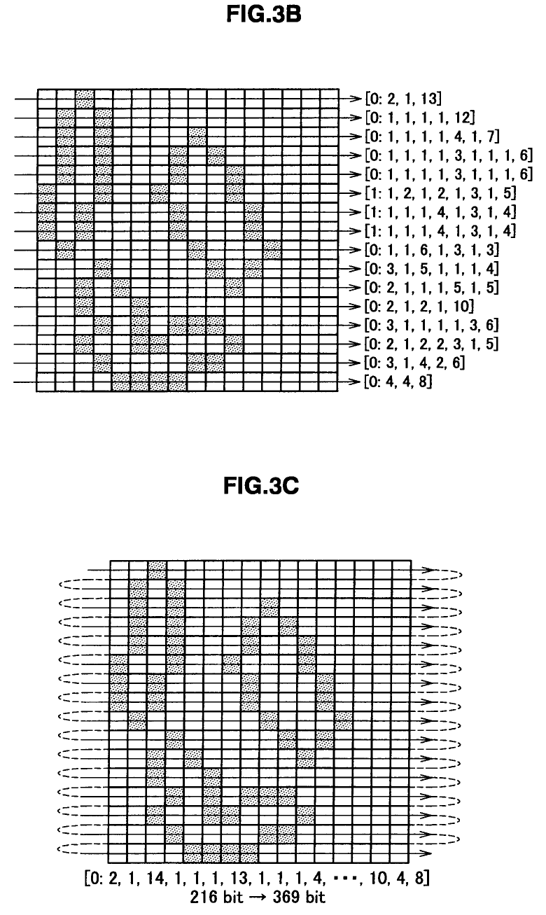

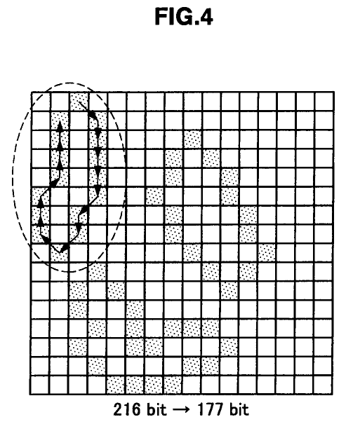

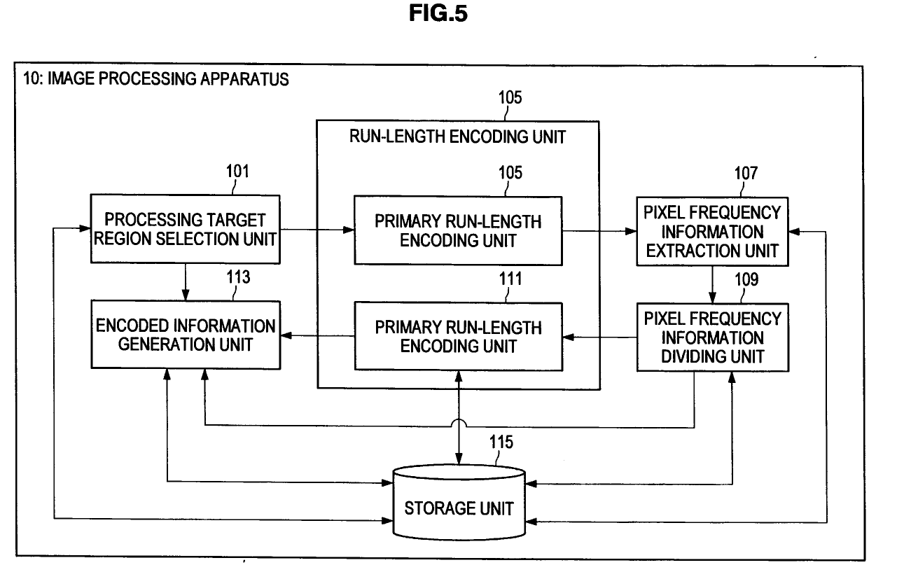

Subsequently, the run-length encoding method and the chain encoding method, i.e., techniques serving as a basis of the present invention, will be explained with reference to FIGS. 2A to 4. FIG. 2A to 3C are explanatory diagrams for illustrating the run-length encoding method. FIG. 4 is an explanatory diagram for illustrating the chain encoding method. In FIGS. 2A to 4, the pixel value of a pixel represented in white is assumed to be 0, and the pixel value of a pixel represented in black is assumed to be 1.

### [Run-Length Encoding Method]

First, the run-length encoding method will be explained.

As described above, the run-length encoding method is a method for compressing an image based on how many pixels having a certain pixel value continuously appear in the image. The binary images used in the present invention have fewer pixels having different pixels values than the other types of images, and the degree of quantization in the binary images used in the present invention is considered to be the most coarse. Therefore, the run-length encoding method is suitable as compression processing performed on the binary images.

For example, compression processing performed in the binary outline image as shown in FIG. 2A will be considered. As shown in FIG. 2A, this image has 16 vertical pixels by 16 horizontal pixels. For example, compression processing performed on each horizontal line of this image by the run-length encoding method will be considered.

In the image shown in FIG. 2A, pixels having the same value are likely to continuously appear on a horizontal line, as is evident from FIG. 2A. The run-length encoding method finds how many white or black pixels appear in each line.

In FIG. 2A, each of all the pixels in the first and second lines from the top has a pixel value “0”. Therefore, data of the pixels in these lines can be compressed by generating data including the pixel value “0” and a frequency “16” instead of generating data including 16 continuous pixel values “0”. In FIG. 2A, the third line from the top includes 6 continuous pixel values “0”, subsequently 6 continuous pixel values “1”, and subsequently 4 continuous pixel values “0”, which are arranged from the left end of the line. Even in this case, the data can be compressed by recording “0, 1, 0” as an array representing the pixel values and recording “6, 6, 4” as an array representing the frequencies instead of recording the pixel value of each of the 16 pixels constituting the line. In other words, in the run-length encoding method, two kinds of arrays, i.e., one-dimensional “array representing pixel values” and one-dimensional “array representing the frequencies” are prepared for a vertical/horizontal two-dimensional image as shown in FIG. 2A.

In this case, the binary image includes not other value but “0” or “1” as the values of the pixel values. Accordingly, the value of the pixel at the beginning of each line (for example, pixel at the left end in FIG. 2A) is recorded at the beginning of the array representing the frequencies instead of providing the array representing the pixel values. In addition, the information representing the frequency of each pixel value is recorded by the above method. As described above, only the pixel value of the pixel at the beginning is recorded, so that it is understood that a number recorded in an even-numbered element is a frequency of a pixel value different from the value of the pixel at the beginning, and a number recorded in an odd-numbered element is a frequency of the same pixel value as the value of the pixel at the beginning. For example, in the third line from the top in FIG. 2A, “1” is recorded in a buffer holding the pixel value of the pixel at the beginning, and subsequently “6, 6, 4” is recorded as an array representing the frequencies. In this recording method, data can be read as follows. The first element of the array representing the frequencies is adopted as the pixel value of the pixel at the beginning. The second element of the array representing the frequencies is adopted as the value different from the pixel value of the pixel at the beginning, and the third and subsequent elements thereof are alternately adopted as either “0” or “1”. When this kind of method is employed, each line of the image as shown in FIG. 2A is represented by data as shown in FIG. 2B.

In the notation as shown in FIG. 2B, a number at the left side of a colon “:” represents a pixel value of a pixel located at the left end of a line. A number at the right side of a colon “:” is a numerical value representing the number of continuous pixels having a pixel value described at the left side of the colon “:”.

When the run-length encoding method is applied according to the above method, the image of FIG. 2A having 216 bits of data can be compressed into 174 bits of data.

When the feature of alternate arrangement of “0” and “1” is used, each line of the image may not be separately treated as shown in FIG. 2B. Alternatively, the entire image may be treated as one line as shown in FIG. 2C, whereby the compression efficiency can be further improved.

In other words, as shown in FIG. 2C, processing is performed in a direction indicated by arrows in the figure, so that the entire image is treated as one line. In this case, the image shown in FIG. 2C is not treated as having 16 rows each of which has 16 pixels (16 pixels×16 rows). Instead, the image shown in FIG. 2C is treated as an image of 256 pixels×1 row. In this case, the image can be encoded by the run-length encoding method upon recording the pixel value of only the pixel at the beginning of the image instead of recording the pixel value of the pixel at the beginning of each line. When this method is used, the image of FIG. 2A having 216 bits of data can be compressed into 169 bits of data as shown in FIG. 2C.

As described above, when the images shown in FIGS. 2A to 2C are compressed in which the pixel values do not change so frequently, the image data can be efficiently compressed by the run-length encoding method as described above. However, when the run-length encoding method is applied to, for example, a contour image as shown in FIG. 3A, the compression efficiency decreases. Compression of an image different from FIG. 2A using the run-length encoding method will be hereinafter explained with reference to FIGS. 3A to 3C.

In the image shown in FIG. 2A, a portion where the pixel value is “1” is concentrated in one portion. Therefore, in FIG. 2A, the frequency of change between the pixel value “0” and the pixel value “1” is low. On the other hand, in the image shown in FIG. 3A, a portion where the pixel value is “1” is not concentrated. In the image of FIG. 3A, change between the pixel value “0” and the pixel value “1” frequently occurs. In the image shown in FIG. 3A, the frequency of the change of the pixel value is high which needs a large size of memory in order to generate an array representing the frequencies.

In other words, the binary image includes either “0” or “1” as the pixel values. Therefore, the value of a pixel value of the binary image can be represented using one bit in the memory. In contrast, a frequency can be a value larger than 1. Therefore, several bits are necessary in the memory to store a number representing a frequency. For this reason, when the number of elements in an array representing the frequencies increases, the number of necessary bits greatly increases.

For example, when the data format shown in FIG. 2B is employed, the maximum value of frequency is “16”, and therefore, each element of the array representing the frequencies needs 4 bits in the memory. Therefore, in the case of the outline image shown in FIG. 3A, the number of elements of the array representing the frequencies also increases, and the data format shown in FIG. 2B occupies a larger area in the memory than the original image represented in units of bits.

For example, when each line of the image shown in FIG. 3A is compressed, the number of elements in each line of the array representing the frequencies increases as shown in FIG. 3B, which increases the size of the image to 436 bits from original 216 bits. Even when the entire image is processed as one line as shown in FIG. 3C, the processed image occupies 369 bits, which is larger than the size of the original image.

As described above, the run-length encoding method can efficiently compress the binary images as shown in FIGS. 1B and 1D. However, the run-length encoding method may not efficiently compress the images in which the pixel values change frequently, such as the character image shown in FIG. 1A and the vein pattern image shown in FIG. 1C.

### [Chain Encoding Method]

Subsequently, the chain encoding method will be explained with reference to FIG. 4.

In this method, encoding operation is performed not based on an image but based on curves in an image. When encoding operation is performed based on the curves in the image, it is the most simple compression method to memorize the coordinates of all the points on a curve. However, this method may not efficiently perform compression either, since the coordinate at each point on a curve occupies a plurality of bits for each of the x and y directions whereas each pixel value in a binary image occupies one bit. Therefore, in the chain encoding method, an image is compressed according to the method as described below.

First, in the chain encoding method, an end point of a curve is detected, and the curve is tracked based on the detected end point in view of neighborhood information about a point in question. In other words, in the chain encoding method, the pixel values of eight points around each point are looked up so as to detect a direction in which the curve subsequently extends, i.e., “extension direction”. Subsequently, in the chain encoding method, numbers 0 to 7 are assigned to these eight types of “extension directions”. Accordingly, each point of the curve needs one piece of “extension direction”. In other words, each point needs three bits. Therefore, in the chain encoding method, the number of bits necessary in the memory is substantially three times the number of points on the curve in the image. Strictly speaking, however, the memory also needs areas for storing coordinates of starting points. Therefore, the number of necessary bits is a little bit more than about three times the number of bits.

For example, compression of the image shown in FIG. 3A using the chain encoding method as shown in FIG. 4 will be considered. In this case, in FIG. 4, attention is given to a curve in a region enclosed by a broken line. In the chain encoding method, the curve is tracked in view of neighborhood information based on, for example, a pixel in the first row from the top and the third column from the left.

When the compression processing is thus performed, the image having 216 bits as shown in FIG. 4 can be compressed to 177 bits.

In the run-length encoding method, attention is given to one pixel adjacent to a given pixel. In the chain encoding method, eight points around a given pixel need to be taken into consideration, and accordingly, it takes computation time (compression processing time). Therefore, the run-length encoding method is superior to the chain encoding method in terms of computation time. This difference in computation time has a great influence in view of a situation where real-time image processing is performed.

Therefore, if a high compression rate can be achieved in the run-length encoding method, the run-length encoding method would be superior to the chain encoding method in terms of application. Accordingly, in each embodiment of the present invention described below, an information processing apparatus and an information processing method capable of compressing a binary outline image with high accuracy (i.e., capable of obtaining a high compression rate) using the run-length encoding method will be explained in detail.

### First Embodiment

### <Configuration of Image Processing Apparatus>

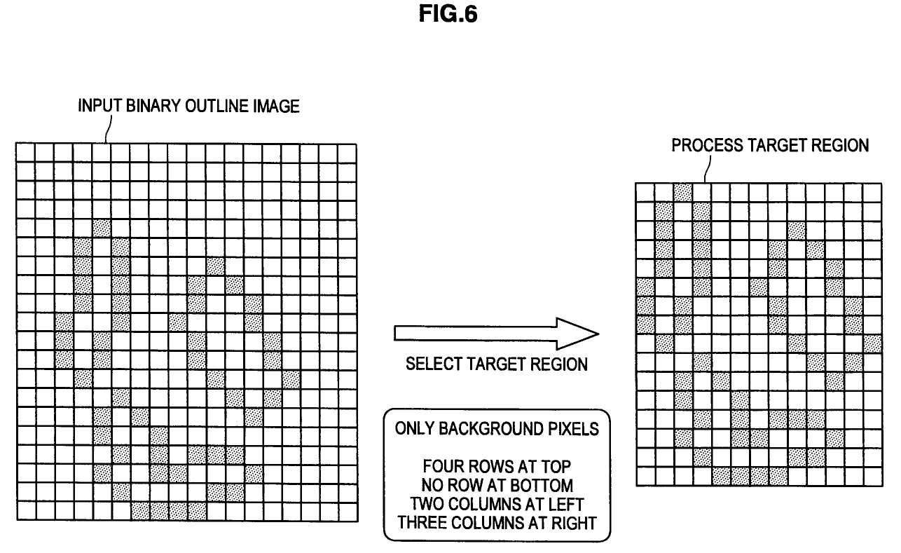

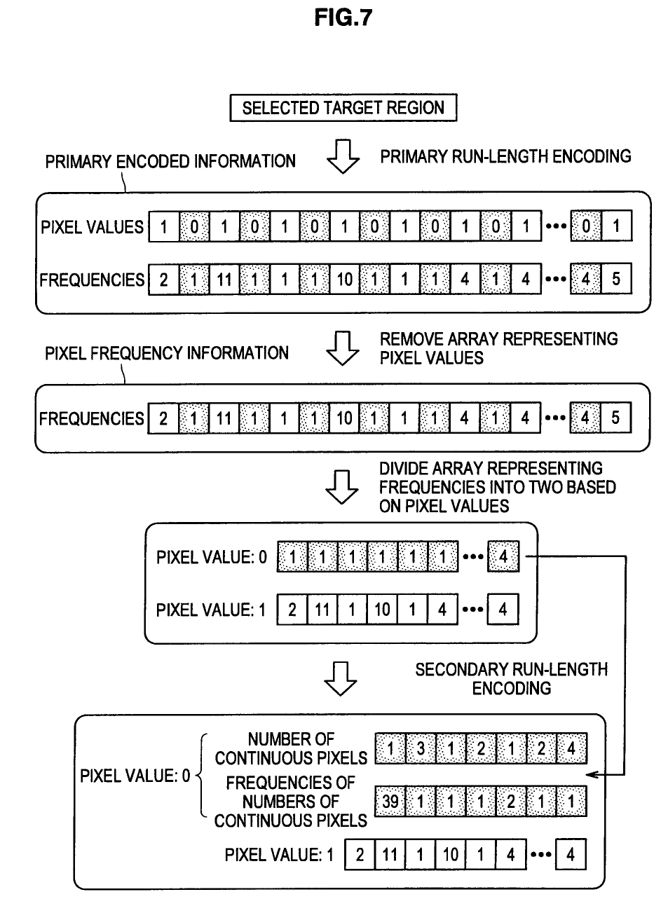

Subsequently, a configuration of an image processing apparatus 10 according to a first embodiment of the present invention will be explained in detail with reference to FIGS. 5 to 7. FIG. 5 is a block diagram for illustrating the configuration of the image processing apparatus 10 according to the present embodiment. FIGS. 6 and 7 are explanatory diagrams for illustrating the image processing apparatus according to the present embodiment.

For example, as shown in FIG. 5, the image processing apparatus 10 according to the present embodiment mainly includes a processing target region selection unit 101, a run-length encoding unit 103, a pixel frequency information extraction unit 107, a pixel frequency information dividing unit 109, an encoded information generation unit 113, and a storage unit 115.

The processing target region selection unit 101 is constituted by, for example, a CPU (Central Processing Unit), a ROM (Read Only Memory), a RAM (Random Access Memory), or the like. The processing target region selection unit 101 determines whether an input binary image has rows or columns including only background pixels, and selects a processing target region, from which the rows or columns including only background pixels have been removed, from pixels representing the binary image.

In this case, the above background pixel mean pixels having pixel values representing background among the pixels constituting the binary image. In the explanation below, pixels having a pixel value representing an outline will be referred to as outline pixels. For example, in the character image shown in FIG. 1A, a pixel represented in black (pixel whose pixel value is 0) corresponds to an outline pixel, and a pixel represented in white (pixel whose pixel value is 1) corresponds to a background pixel. In the vein pattern image shown in FIG. 1C, a pixel represented in white whose pixel value is 1 corresponds to an outline pixel, and a pixel represented in black whose pixel value is 0 corresponds to a background pixel.

More specifically, first, the processing target region selection unit 101 identifies the numbers of rows at the top and the bottom and the numbers of columns at the left and the right including only background pixels in the input image. In the example shown in FIG. 6, four rows at the top in the input image having 18 columns×20 rows are the rows including only background pixels, and two columns at the left and three columns at the right are columns including only background pixels. The processing target region selection unit 101 transmits the identified numbers of rows at the top and the bottom and the identified numbers of columns at the left and the right including only background pixels to the encoded information generation unit 113 later explained. In the example shown in FIG. 6, the processing target region selection unit 101 transmits, to the encoded information generation unit 113, information indicating that the four rows at the top and no line at the bottom are rows including only background pixels and the two columns at the left and the three columns at the right are columns including only background pixels.

Subsequently, the processing target region selection unit 101 transmits, as a processing target region, a region obtained by removing the identified rows or the identified columns including only background pixels to the run-length encoding unit 103 explained later. In the example shown in FIG. 6, 13 columns×16 rows obtained by removing the four rows at the top, the two columns at the left, and the three columns at the right from the input image having 18 columns×20 rows is selected and adopted as the processing target region.

The run-length encoding unit 103 is constituted by, for example, a CPU, a ROM, a RAM, and the like. The run-length encoding unit 103 performs run-length encoding processing on input data, and outputs a data value of each element constituting data and the frequency of the element having each data value. This run-length encoding unit 103 further includes a primary run-length encoding unit 105 and a secondary run-length encoding unit 111 as shown in FIG. 5, for example.

The primary run-length encoding unit 105 is constituted by, for example, a CPU, a ROM, a RAM, and the like. The primary run-length encoding unit 105 uses the run-length encoding method to encode image data corresponding to the processing target region transmitted from the processing target region selection unit 101. More specifically, the primary run-length encoding unit 105 processes the image data corresponding to the transmitted processing target region into image data having a plurality of pixels in one row, and generates an array representing pixel values and an array representing the frequencies. Subsequently, the primary run-length encoding unit 105 transmits, as primary encoded information, the generated array representing pixel values and the generated array representing the frequencies to the pixel frequency information extraction unit 107 explained later.

For example, when the primary run-length encoding unit 105 receives the processing target region shown in FIG. 6, the primary run-length encoding unit 105 generates the primary encoded information including the array representing pixel values in which pixel values “1” and “0” are arranged alternately and the array representing the frequencies whose elements are the frequencies of the respective pixel values as shown in FIG. 7. The primary run-length encoding unit 105 transmits the generated primary encoded information to the pixel frequency information extraction unit 107.

When the first pixel processed (for example, the pixel at the upper left corner) in the processing target region is inevitably an outline pixel or a background pixel, information representing the pixel value of the first pixel may not be recorded at the beginning of the array representing the frequencies as shown in FIG. 7, for example.

The secondary run-length encoding unit 111 will be explained again later in detail.

The pixel frequency information extraction unit 107 is constituted by, for example, a CPU, a ROM, a RAM, and the like. The pixel frequency information extraction unit 107 deletes the array representing pixel values from the primary encoded information including the array representing pixel values and the array representing the frequencies transmitted from the primary run-length encoding unit 105, thereby generating pixel frequency information including only the array representing the frequencies.

For example, when the primary encoded information as shown in FIG. 7 is generated and transmitted to the pixel frequency information extraction unit 107, the pixel frequency information extraction unit 107 extracts the array representing the frequencies by deleting the array representing pixel values from the primary encoded information, thereby generating the pixel frequency information as shown in FIG. 7.

The pixel frequency information extraction unit 107 transmits the generated pixel frequency information to the pixel frequency information dividing unit 109 later explained.

The pixel frequency information dividing unit 109 is constituted by, for example, a CPU, a ROM, a RAM, and the like. The pixel frequency information dividing unit 109 divides the pixel frequency information transmitted from the pixel frequency information extraction unit 107 into an array representing the frequencies of outline pixels and an array representing the frequencies of background pixels. As described above, when the binary image is subjected to the run-length encoding, an odd-numbered element in the array representing the frequencies is the frequency of a pixel having the same pixel value as the pixel value of the first pixel processed in the processing target region. Likewise, an even-numbered element in the array representing the frequencies is the frequency of a pixel having a pixel value opposite to the pixel value of the first pixel processed in the processing target region. Accordingly, the pixel frequency information dividing unit 109 can divide the pixel frequency information into the two types of arrays by determining whether an element in the array is an odd-numbered element or an even-numbered element.

For example, the pixel frequency information as shown in FIG. 7 is divided by the pixel frequency information dividing unit 109 into the two arrays, i.e., the array representing the frequencies of pixels having a pixel value “0” and the array representing the frequencies of pixels having a pixel value “1”.

The pixel frequency information dividing unit 109 transmits the array representing the frequencies of outline pixels to the secondary run-length encoding unit 111. On the other hand, the pixel frequency information dividing unit 109 transmits the array representing the frequencies of background pixels to the encoded information generation unit 113 explained later.

In the binary outline image, the thickness (width) of an outline has substantially the same value, and accordingly, the array representing the frequencies of outline pixels stores substantially the same value. Therefore, the array representing the frequencies of outline pixels can be further compressed by compressing the array representing the frequencies of outline pixels using the run-length encoding again. For this reason, the pixel frequency information dividing unit 109 according to the present embodiment transmits the generated array representing the frequencies of outline pixels to the secondary run-length encoding unit 111. On the other hand, in many cases, the array representing the frequencies of background pixels often stores a wide variety of values, and accordingly, the array representing the frequencies of background pixels may not be further compressed even when it is compressed using the run-length encoding again. Therefore, the pixel frequency information dividing unit 109 according to the present embodiment does not transmit the array representing the frequencies of background pixels to the secondary run-length encoding unit 111.

The secondary run-length encoding unit 111 is constituted by, for example, a CPU, a ROM, a RAM, and the like. The secondary run-length encoding unit 111 uses the run-length encoding method to encode the array representing the frequencies of outline pixels transmitted from the pixel frequency information dividing unit 109. As a result, an array representing the numbers of outline pixels appearing continuously (the number of continuous outline pixels) and an array representing the frequencies of the numbers of continuous outline pixels are generated from the array representing the frequencies of outline pixels.

For example, in the example shown in FIG. 7, the number of continuous outline pixels is “1” (in this case, both adjacent pixels of an outline pixel are background pixels). The array representing the numbers of continuous outline pixels includes 3, 1, 2, 1, 2, 4, and the array representing the respective frequencies thereof includes 39, 1, 1, 1, 2, 1, 1.

The secondary run-length encoding unit 111 transmits the generated array representing the numbers of continuous outline pixels and the generated array representing the frequencies of the numbers of continuous outline pixels to the encoded information generation unit 113 explained later.

As a result of the encoding processing described above, the image data representing the processing target region shown in FIG. 6 are compressed into information shown at the bottom of FIG. 7.

The encoded information generation unit 113 is constituted by, for example, a CPU, a ROM, a RAM, and the like. The encoded information generation unit 113 receives the information representing rows and columns including only background pixels transmitted from the processing target region selection unit 101 and the array representing the frequencies of background pixels transmitted from the pixel frequency information dividing unit 109. The encoded information generation unit 113 receives the array representing the numbers of continuous outline pixels and the array representing the frequencies of the numbers of continuous outline pixels from the secondary run-length encoding unit 111. The encoded information generation unit 113 associates the thus received pieces of information with each other, and adopts them as encoded information obtained by encoding the input binary outline image.

The storage unit 115 stores various kinds of information generated by the image processing apparatus 10 according to the present embodiment. In addition, the storage unit 115 may store the encoded information generated by the image processing apparatus 10 according to the present embodiment. In addition, the storage unit 115 may store, for example, various parameters or progress of processing that need to be stored while the image processing apparatus 10 according to the present embodiment performs certain processing, and may store various kinds of databases and the like as necessary. The storage unit 115 can be freely read and written by the processing target region selection unit 101, the run-length encoding unit 103, the primary run-length encoding unit 105, the pixel frequency information extraction unit 107, the pixel frequency information dividing unit 109, the secondary run-length encoding unit 111, and the encoded information generation unit 113.

In the above explanation, the image processing apparatus 10 according to the present embodiment processes the image in the horizontal direction from the upper left to the lower right. However, the direction is not limited to the above example. The image may be processed in the horizontal direction from the upper right to the lower left. Alternatively, the process may be performed in the vertical direction from the upper left to the lower right, or the process may be performed in the vertical direction from the upper right to the lower left.

In the above explanation, the secondary run-length encoding is not performed on the array representing the frequencies of background pixels. However, the processing is not limited to the above example. For example, the array representing the frequencies of background pixels may be encoded with the secondary run-length encoding, and when the size of the encoded data is less than the size of the uncompressed data, the compressed data may be used as the encoded information about background pixels.

Examples of the functions of the image processing apparatus 10 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described image processing apparatus according to the present embodiment, and the computer program can be implemented on a personal computer and the like. Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

### <Image Processing Method>

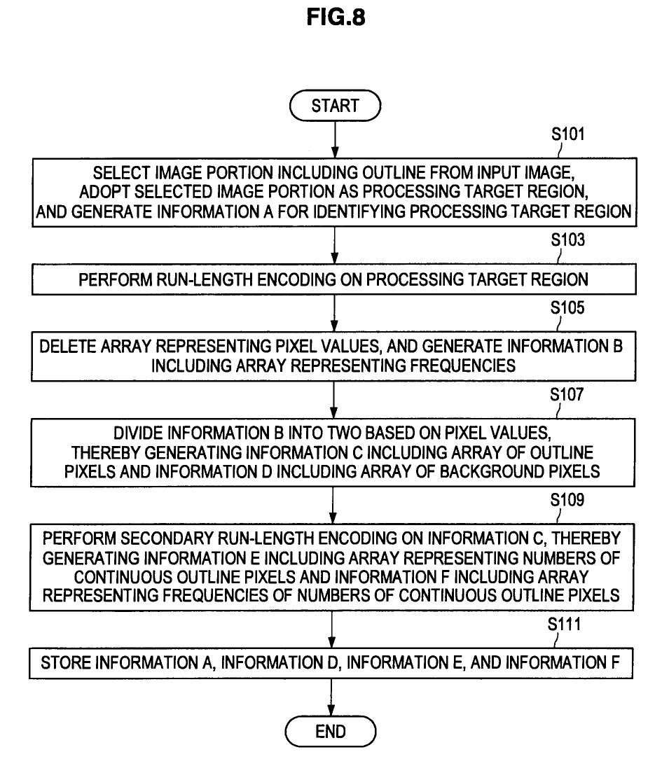

Subsequently, the image processing method according to the present embodiment will be explained in detail with reference to FIG. 8. FIG. 8 is a flow diagram for illustrating the image processing method according to the present embodiment.

First, the processing target region selection unit 101 selects, as a processing target region, an image portion including an outline from an input binary outline image, and generates information A for identifying the processing target region (step S101). The information A identifying the processing target region is information representing the numbers of rows and columns including only background pixels shown in FIG. 6, for example. The processing target region selection unit 101 transmits the selected processing target region to the primary run-length encoding unit 105.

Subsequently, the primary run-length encoding unit 105 performs the run-length encoding on the processing target region selected by the processing target region selection unit 101 (step S103), thereby generating the primary encoded information. The primary run-length encoding unit 105 transmits the generated primary encoded information to the pixel frequency information extraction unit 107.

Subsequently, the pixel frequency information extraction unit 107 extracts the array representing the frequencies by deleting the array representing pixel values from the primary encoded information transmitted from the primary run-length encoding unit 105, and adopts the array representing the frequencies as information B (step S105). The information B corresponds to the pixel frequency information. The pixel frequency information extraction unit 107 transmits the extracted information B to the pixel frequency information dividing unit 109.

Subsequently, the pixel frequency information dividing unit 109 divides, based on the pixel values, the information B transmitted from the pixel frequency information extraction unit 107 into two pieces, thereby generating information C including the array of outline pixels and information D including the array of background pixels (step S107). The pixel frequency information dividing unit 109 transmits the generated information C to the secondary run-length encoding unit 111, and transmits the generated information D to the encoded information generation unit 113.

Subsequently, the secondary run-length encoding unit 111 further performs the run-length encoding on the information C transmitted from the pixel frequency information dividing unit 109, thereby generating information E including the array representing the numbers of continuous outline pixels and information F including the array representing the frequencies of the numbers of continuous outline pixels (step S109). The secondary run-length encoding unit 111 transmits the generated information E and the generated information F to the encoded information generation unit 113.

Subsequently, the encoded information generation unit 113 associates the received information A, the received information D, the received information E, and the received information F with each other, adopts them as the encoded information, and stores the encoded information (step S111).

As described above, in the image processing method according to the present embodiment, the run-length encoding method having a light calculation load is applied twice, so that the array representing the frequencies of outline pixels can be efficiently compressed, and the binary outline pixel can be compressed with high accuracy at a high speed.

### <Actual Result of Processing>

Subsequently, a result obtained by performing compression processing using the image processing method according to the present embodiment will be explained in detail. In this compression processing, a thinned finger vein image used for vein authentication processing is used as an example of a binary outline image.

In the compression processing, two kinds of thinned finger vein images are used. The size of each vein image is 160×60 pixels. When the compression processing is not performed, the size of each vein image is 9600 bits, i.e., 1200 bytes.

Each vein image is compressed using three kinds of compression processings, i.e., the image processing method according to the present embodiment, generally-available run-length encoding method, and generally-available chain encoding method. The compression processing is executed under the same condition except for the compression method. In each of the compression methods, the size of the compressed image and a computation time necessary for the compression processing are compared.

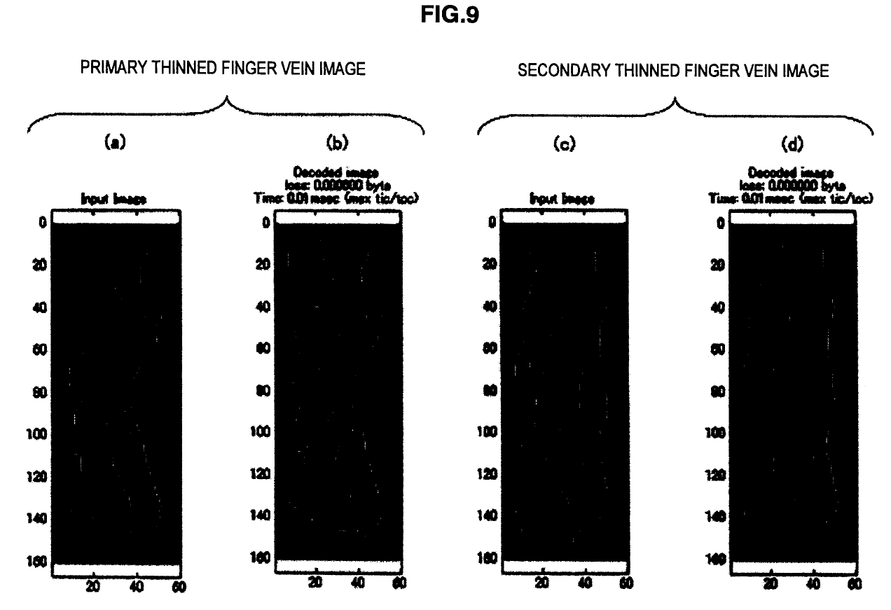

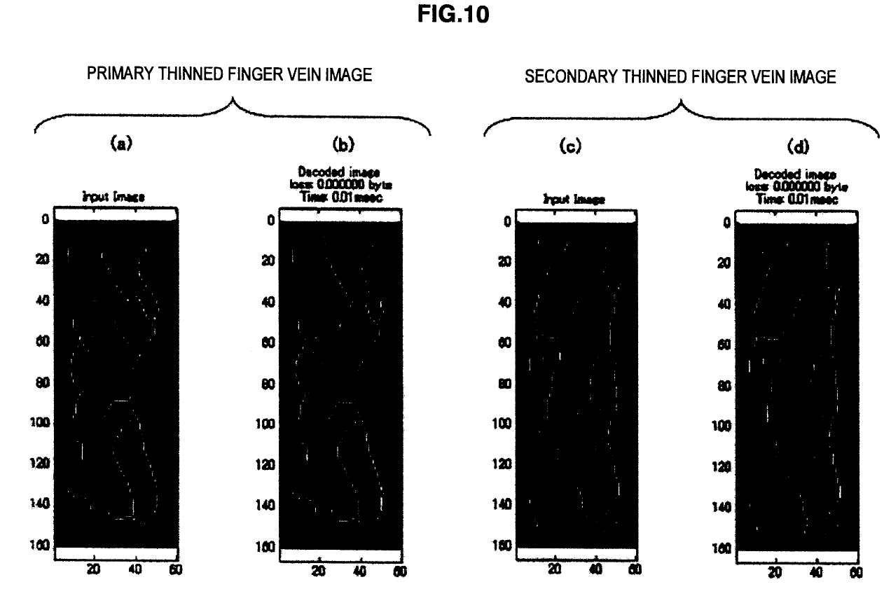

The first thinned finger vein image used for the compression processing is an image shown in item (a) of FIG. 9. The second thinned finger vein image used for the compression processing is an image shown in item (c) of FIG. 9.

The obtained results are shown in Table 1 and Table 2 below. FIG. 9 is an explanatory diagram for illustrating a result obtained by performing the image processing method according to the present embodiment. FIG. 10 is an explanatory diagram for illustrating a result obtained by performing compression processing according to the generally-available chain encoding method.

TABLE 1
Result of processing on first thinned finger vein image

| | | | Image | |
|---|---|---|---|---|
| | | | processing | |
| | | | method | |
| | | Run-length | according to | Chain |
| | Standard | encoding | the present | encoding |
| | image | method | embodiment | method |
| Image size | 1200 | 853 | 365 | 232 |
| (byte) | | | | |
| Computation | — | 0.03 | 0.04 | 0.06 |
| time | | | | |
| (msec) | | | | |

TABLE 2
Result of processing on second thinned finger vein image

| | | | Image | |
|---|---|---|---|---|
| | | | processing | |
| | | | method | |
| | | Run-length | according to | Chain |
| | Standard | encoding | the present | encoding |
| | image | method | embodiment | method |
| Image size | 1200 | 909 | 370 | 222 |
| (byte) | | | | |
| Computation | — | 0.03 | 0.03 | 0.06 |
| time | | | | |
| (msec) | | | | |

First, see FIGS. 9 and 10. In FIGS. 9 and 10, item (a) illustrates the first thinned finger vein image to be processed, and item (b) illustrates a result obtained by performing decompression processing on a compressed image. Likewise, item (c) illustrates the second thinned finger vein image to be processed, and item (b) illustrates a result obtained by performing decompression processing on a compressed image.

As can be seen from FIGS. 9 and 10, in the image processing method according to the present embodiment and the generally-available chain encoding method, the images obtained from the decompression processings are the same as input images. Therefore, it is understood that the images are not deteriorated by the compression processing and the decompression processing.

Table 1 shows that an image whose original size is 1200 bytes is compressed into 853 bytes by the generally-available run-length encoding method, into 365 bytes by the image processing method according to the present embodiment, and into 232 bytes by the generally-available chain encoding method. This means that the image size of the input image is compressed into about 71%, about 30%, and about 19%, respectively. The computation time of the generally-available run-length encoding method is 0.03 msec. The computation time of the image processing method according to the present embodiment is 0.04 msec. The generally-available chain encoding method is 0.06 msec.

Table 2 shows that an image whose original size is 1200 bytes is compressed into 909 bytes by the generally-available run-length encoding method, into 370 bytes by the image processing method according to the present embodiment, and into 222 bytes by the generally-available chain encoding method. This means that the image size of the input image is compressed into about 76%, about 31%, and about 19%, respectively. The computation time of the generally-available run-length encoding method is 0.03 msec. The computation time of the image processing method according to the present embodiment is 0.03 msec. The computation time of the generally-available chain encoding method is 0.06 msec.

As is evident from the results shown in Tables 1 and 2, the image processing method according to the present embodiment has compression performance which is slightly lower than the generally-available chain encoding method but is about 2.5 times higher than the generally-available run-length encoding method. The computation time of the image processing method according to the present embodiment is about the same as the computation time of the generally-available run-length encoding method, but it is understood that the image processing method according to the present embodiment finishes the processing in the computation time which is half the computation time of the generally-available chain encoding method.

As described above, it is understood that the image processing method according to the present embodiment can perform lossless compression on the binary outline image with high accuracy at a high speed.

### <Hardware Configuration>

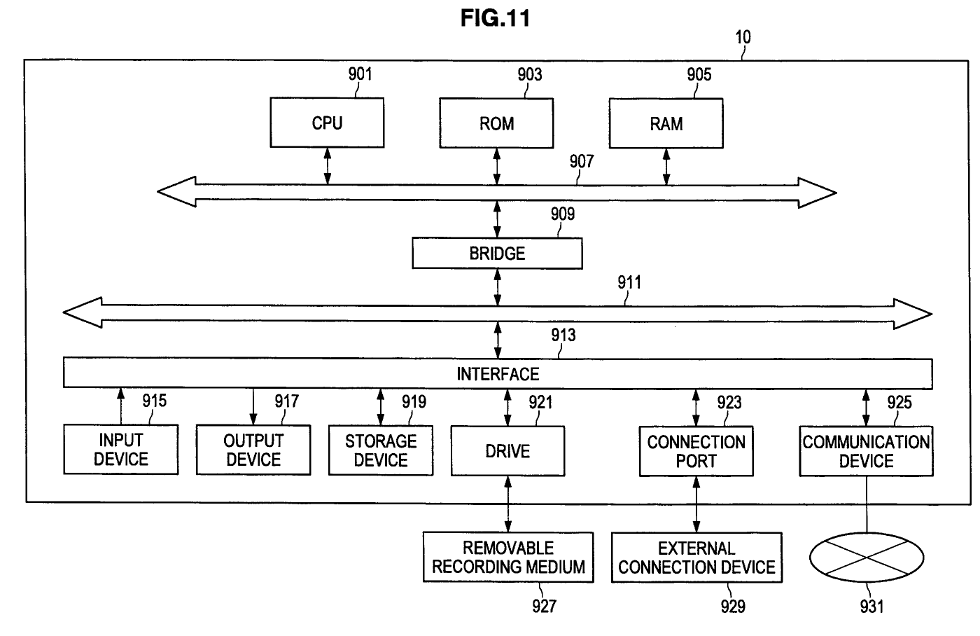

Subsequently, a hardware configuration of the image processing apparatus 10 according to an embodiment of the present invention will be explained in detail with reference to FIG. 11. FIG. 11 is a block diagram for illustrating a hardware configuration of the image processing apparatus 10 according to the embodiment of the present invention.

The image processing apparatus 10 mainly includes a CPU 901, a ROM 903, and a RAM 905. The image processing apparatus 10 further includes a host bus 907, a bridge 909, an external bus 911, an interface 913, an input device 915, an output device 917, a storage device 919, a drive 921, a connection port 923, and a communication device 925.

The CPU 901 functions as a calculation processing unit and a control device, so as to control overall operation or a portion thereof in the image processing apparatus 10 in accordance with various kinds of programs recorded in the ROM 903, the RAM 905, the storage device 919, or a removable recording medium 927. The ROM 903 stores programs, calculation parameters, and the like which are used by the CPU 901. The RAM 905 temporarily stores programs used during execution of the CPU 901 and parameters and the like which change as necessary during the execution. These are connected with each other by the host bus 907 constituted by an internal bus such as a CPU bus.

The host bus 907 is connected to the external bus 911 such as a PCI (Peripheral Component Interconnect/Interface) bus via the bridge 909.

The input device 915 is input means operated by a user, such as a mouse, a keyboard, a touch panel, buttons, switches and levers. Further, the input device 915 may be remote control means (a so-called remote controller) using infrared light and other radio waves, for example. Alternatively, the input device 915 may be an external connection device 929 such as a portable telephone and a PDA with which the image processing apparatus 10 can be operated. Further, the input device 915 is constituted by an input control circuit for generating an input signal based on information given by a user with the above operation means and outputting the input signal to the CPU 901, for example. By operating this input device 915, the user of the image processing apparatus 10 can input various kinds of data to the image processing apparatus 10 and give instructions for processing operation to the image processing apparatus 10.

The output device 917 is constituted by a device capable of notifying the obtained information to the user in a visual or audible manner. Examples of such devices include a display device such as a CRT display device, a liquid crystal display device, a plasma display device, an EL display device and lamps, an audio output device such as a speaker and a headphone, and a printer, a portable telephone, and a facsimile machine. The output device 917 outputs results obtained as a result of various kinds of processing performed by the image processing apparatus 10, for example. More specifically, the display device displays, as a text or an image, a result obtained from the various kinds of processing performed by the image processing apparatus 10. On the other hand, the audio output device converts an audio signal containing reproduced audio data, acoustic data, and the like into an analog signal and outputs the analog signal.

The storage device 919 is a data storage device configured as an example of a storage unit for the image processing apparatus 10. The storage device 919 may be constituted by a magnetic storage device such as a hard disk drive (HDD), a semiconductor storage device, an optical storage device, a magneto-optical storage device, or the like. The storage device 919 stores programs to be executed by the CPU 901, various kinds of data, and various kinds of data obtained from the outside such as image data, for example.

The drive 921 is a reader/writer for a recording medium, which is built in the image processing apparatus 10 or attached externally. The drive 921 reads information that is recorded in the removable recording medium 927 such as a magnetic disk, an optical disk, a magneto-optical disk, and a semiconductor memory, which is attached thereto and outputs the information to the RAM 905. Further, the drive 921 can write recordings to the removable recording medium 927 such as a magnetic disk, an optical disk, a magneto-optical disk, and a semiconductor memory, which is attached thereto. The removable recording medium 927 may be a DVD medium, an HD-DVD medium, a Blu-ray medium, and the like. Alternatively, the removable recording medium 927 may be a compact flash (CF) (registered trademark), a memory stick, a secure digital (SD) memory card, and the like. Further, the removable recording medium 927 may be, for example, an integrated circuit (IC) card including a contactless IC chip, an electronic device, and the like.

The connection port 923 is a port for directly connecting equipment to the image processing apparatus 10. Examples of the connection port 923 include a universal serial bus (USB) port, an IEEE 1394 port such as i.Link, and a small computer system interface (SCSI) port. In addition, other examples of the connection port 923 include an RS-232C port, an optical audio terminal, and a high-definition multimedia interface (HDMI) port. By connecting the external connection device 929 to the connection port 923, the image processing apparatus 10 can directly obtain various kinds of data from the external connection device 929 and supply various kinds of data to the external connection device 929.

The communication device 925 is a communication interface that is configured by a communication device and the like for establishing a connection with a communication network 931, for example. The communication device 925 may be a communication card for wired or wireless local area network (LAN), Bluetooth, wireless USB (WUSB), and the like. Alternatively, the communication device 925 may be a router for optical communication, a router for asymmetric digital subscriber line (ADSL), a modem for various kinds of communications, or the like. The communication device 925 can transmit and receive a signal and the like to and from the Internet or another communication device in accordance with a predetermined protocol such as TCP/IP, for example. Further, the communication network 931 that is connected to the communication device 925 is constituted by a network and the like connected by wired or wireless means. The network may be the Internet, home LAN, infrared data communication, radio wave communication, satellite communication, or the like.

An example of hardware configuration capable of achieving functions of the image processing apparatus 10 according to each embodiment of the present invention has been hereinabove explained. Each of the above constituent elements may be structured using a general-purpose member, or may be structured by hardware dedicated to the function of each constituent element. Therefore, the used hardware configuration may be changed as necessary in accordance with the state of the art at the time when the present embodiment is carried out.

### <Summary>

As described above, the image processing apparatus and the image processing method according to each embodiment of the present invention make use of the following features of the binary outline image, thus being capable of performing lossless compression on the binary outline image with high accuracy at a high speed.

(1) The binary image includes only the pixel value “1” and pixel value “0”.

Therefore, the image processing apparatus and the image processing method according to each embodiment of the present invention does not need to have the “array representing pixel values”, which is used in the run-length encoding method.

(2) The “array representing the frequencies”, used in the run-length encoding method, is divided into a set of even-numbered elements and a set of odd-numbered elements. The array representing the frequencies of each pixel value can be generated separately.

(3) In the binary outline image, an outline has substantially the same width. Accordingly, the array representing the frequencies of outline pixels include elements having similar values.

(4) In the binary outline image, a plurality of horizontal lines in proximity to the upper end and the lower end and a plurality of vertical lines in proximity to the right end and the left end often include only background pixels.

In the image processing apparatus and the image processing method according to each embodiment of the present invention, an image to be processed is treated as data having a plurality of pixels in one line, and the run-length encoding method is performed twice, so that the data array of outline pixels can be efficiently compressed. As a result, the image processing apparatus and the image processing method according to each embodiment of the present invention can improve compression performance while suppressing the computation time necessary for the compression process.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

In the above explanation, the processing target region is divided into a plurality of rows in units of pixels, and the run-length encoding processing is performed on one data array in which the plurality of rows are connected in order. However, the embodiment is not limited to the above example. The processing target region may be divided into a plurality of columns, and the run-length encoding processing may be performed on a data array generated by connecting the plurality of columns in order.

1. An image processing apparatus comprising:
a processing target region selection unit for determining whether a binary image including a background pixel having a pixel value representing a background and an outline pixel having a pixel value representing an outline includes any row or column including only the background pixels, and selecting, from pixels representing the binary image, a processing target region from which the row and the column including only the background pixels have been removed;
a run-length encoding unit for performing run-length encoding processing on input data, and outputting a data value of each element constituting the data and a frequency of the element having the data value;
a pixel frequency information extraction unit for extracting pixel frequency information representing frequencies of the background pixel and the outline pixel constituting the target region from among output values of the processing target region processed by the run-length encoding unit; and
a pixel frequency information dividing unit for dividing the pixel frequency information extracted by the pixel extraction unit into frequency information about the background pixel and frequency information about the outline pixel,
wherein the run-length encoding unit performs the run-length encoding processing on the frequency information about the outline pixel.

2. The image processing apparatus according to claim 1,
wherein the run-length encoding unit divides the processing target region into a plurality of rows or columns in units of pixels, and performs the run-length encoding processing on one data array obtained by connecting the plurality of rows or columns in order.

3. The image processing apparatus according to claim 2,
wherein the run-length encoding unit performs the run-length encoding processing on the frequency information about the outline pixel to output information about the number of continuous outline pixels and information about a frequency of the number of continuous outline pixels, and
the image processing apparatus further includes an encoded information generation unit for obtaining encoded information, which is information obtained by encoding the binary image, upon associating, with each other, information about the number of the rows and the columns including only the background pixels, the frequency information about the background pixel, the information about the number of continuous outline pixels, and the information about the frequency of the number of continuous outline pixels.

4. The image processing apparatus according to claim 1,
wherein a curve representing an outline constituted by the outline pixels has substantially the same width.

5. The image processing apparatus according to claim 1,
wherein the binary image is a binary image of a vein existing in a living body.

6. An image processing method comprising the steps of:
determining whether a binary image including a background pixel having a pixel value representing a background and an outline pixel having a pixel value representing an outline includes any row or column including only the background pixels, and selecting, from pixels representing the binary image, a processing target region from which the row and the column including only the background pixels have been removed;
performing run-length encoding processing on data representing the processing target region, and outputting a pixel value of each pixel constituting the data representing the processing target region and a frequency of the pixel having the pixel value;
extracting pixel frequency information representing frequencies of the background pixel and the outline pixel constituting the target region from among output values of the processing target region;
dividing the extracted pixel frequency information into frequency information about the background pixel and frequency information about the outline pixel; and
performing the run-length encoding processing on the frequency information about the outline pixel.

7. A program for causing a computer to execute:
a procedure for determining whether a binary image including a background pixel having a pixel value representing a background and an outline pixel having a pixel value representing an outline includes any row or column including only the background pixels, and selecting, from pixels representing the binary image, a processing target region from which the row and the column including only the background pixels have been removed;
a procedure for performing run-length encoding processing on data representing the processing target region, and outputting a pixel value of each pixel constituting the data representing the processing target region and a frequency of the pixel having the pixel value;
a procedure for extracting pixel frequency information representing frequencies of the background pixel and the outline pixel constituting the target region from among output values of the processing target region;
a procedure for dividing the extracted pixel frequency information into frequency information about the background pixel and frequency information about the outline pixel; and
a procedure for performing the run-length encoding processing on the frequency information about the outline pixel.
